(19) United States
(12) Patent Application Publication
(10) Pub. No.: US 2021/0198904 A1
(43) Pub. Date: Jul. 1, 2021

(54) User Attachable Overhead Panel Support Device

(71) Applicant: Jose Torres, Knoxville, TN (US)

(72) Inventor: Jose Torres, Knoxville, TN (US)

(21) Appl. No.: 16/728,091

(22) Filed: Dec. 27, 2019

(51) Int. Cl. E04F 21/18; F16M 13/04

(52) U.S. Cl. CPC E04F 21/1805; F16M 13/04; E04F 21/1844

(57) ABSTRACT

A user attachable overhead panel support device for positioning a panel for attachment to an overhead substrate includes a harness that is configured to position on and to couple to a torso of a user. Each of a pair of shoulder straps of the harness is positioned over a respective shoulder of the user. A pair of posts is coupled singly to the pair of shoulder straps. The posts are substantially parallel and substantially vertically positioned when the user is uprightly positioned. Each of a pair of plates is coupled to an upper end of a respective one of the pair of posts. The pair of plates is configured to support the panel overhead, enabling the user to position the panel in abutment to the overhead substrate. Hands of the user remain free for fastening the panel to the substrate.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to panel support devices and more particularly pertains to a new panel support device for positioning a panel for attachment to an overhead substrate.

### (2) Description of Related Art Including Information Disclosed under 37 CFR 1.97 and 1.98.

The prior art relates to panel support devices. Prior art panel support devices may comprise one or two poles that are attached to a back of a vest, shoulder engaging brackets with a portion of the bracket above the head, and handheld or floor engaging poles with a panel support on an upper end of the pole

### BRIEF SUMMARY OF THE INVENTION

An embodiment of the disclosure meets the needs presented above by generally comprising a harness that is configured to position on and to couple to a torso of a user. Each of a pair of shoulder straps of the harness is positioned over a respective shoulder of the user. A pair of posts is coupled singly to the pair of shoulder straps. The posts are substantially parallel and substantially vertically positioned when the user is uprightly positioned. Each of a pair of plates is coupled to an upper end of a respective one of the pair of posts. The pair of plates is configured to support a panel, enabling the user to position the panel in abutment to an overhead substrate. Hands of the user remain free for fastening the panel to the substrate.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front in-use view of a user attachable overhead panel support device according to an embodiment of the disclosure.

FIG. 2 is a back view of an embodiment of the disclosure.

FIG. 3 is a side view of an embodiment of the disclosure.

FIG. 4 is an exploded view of an embodiment of the disclosure.

FIG. 5 is a detail view of an embodiment of the disclosure.

### DETAILED DESCRIPTION OF THE INVENTION

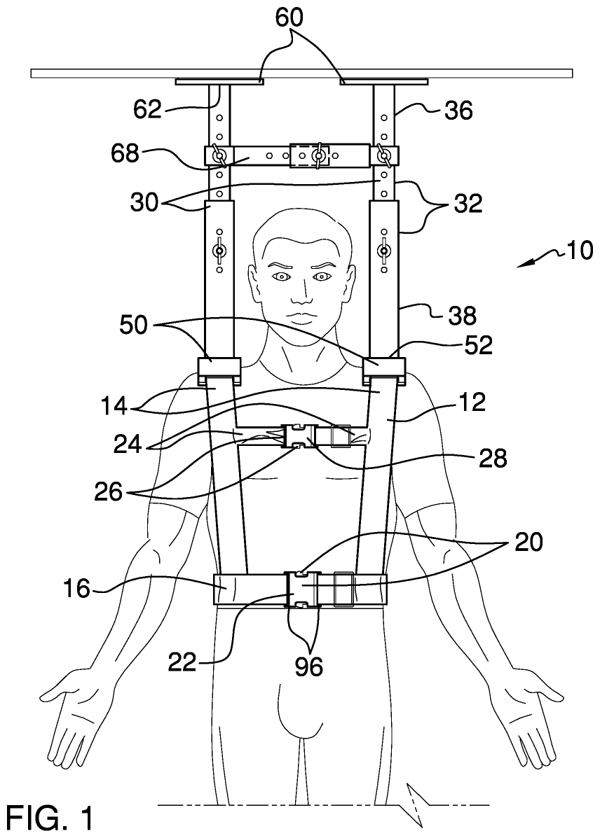

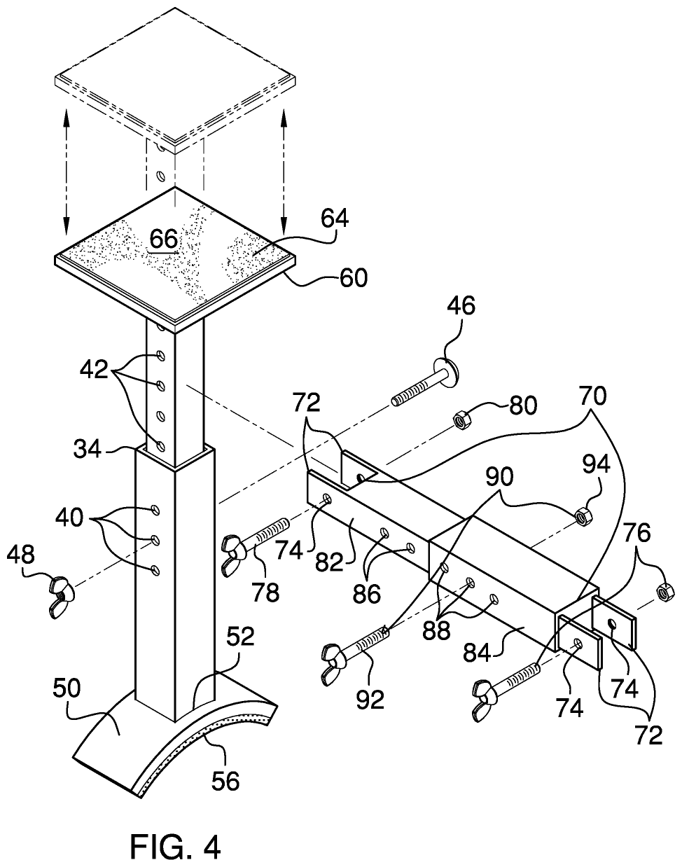

With reference now to the drawings, and in particular to FIGS. 1 through 5 thereof, a new panel support device embodying the principles and concepts of an embodiment of the disclosure and generally designated by the reference numeral 10 will be described.

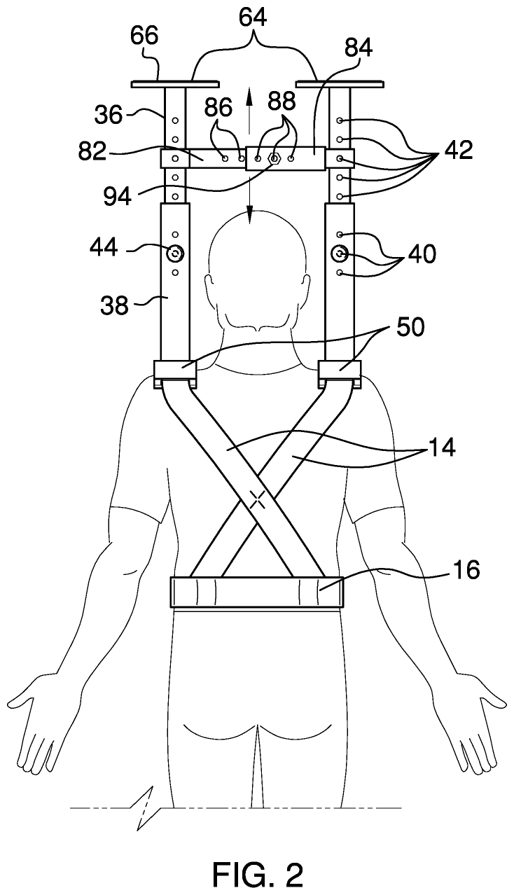

As best illustrated in FIGS. 1 through 5, the user attachable overhead panel support device 10 generally comprises a harness 12 that is configured to position on and to couple to a torso of a user. Each of a pair of shoulder straps 14 of the harness 12 is positioned over a respective shoulder of the user. The harness 12 comprises a belt 16 that is configured to position around and to couple to a waist of the user. Each shoulder strap 14 has opposing ends 18 that are coupled to the belt 16. The shoulder straps 14 cross and are mutually coupled distal from opposing termini 96 of the belt 16. As such, the pair of shoulder straps 14 is X-shaped along a back of the user, as shown in FIG. 2.

One coupler 20 of a pair of couplers 20 is engaged to one of the opposing termini 96 of the belt 16. The other coupler 20 of the pair of couplers 20 is slidably engaged to the belt 16 proximate to the other of the opposing termini 96. The couplers 20 are selectively mutually engageable and thus are configured to removably couple the belt 16 around the waist of the user. The pair of couplers 20 may comprise a waist side release buckle 22, or other coupling means, such as, but not limited to, hook and loop fasteners, tongue buckles, double ring buckles, and the like.

Each of a pair of cross straps 24 is coupled to and extends from a respective one of the pair of shoulder straps 14. One connector 26 of a pair of connectors 26 is engaged to one of the cross straps 24 distal from an associated shoulder strap 14. The other connector 26 of the pair of connectors 26 is slidably engaged to the other of the cross straps 24 distal from an associated shoulder strap 14. The connectors 26 are selectively mutually engageable and thus are configured to secure the pair of cross straps 24 across a chest of the user. The pair of connectors 26 may comprise a chest side release buckle 28, or other connecting means, such as, but not limited to, hook and loop fasteners, tongue buckles, double ring buckles, and the like.

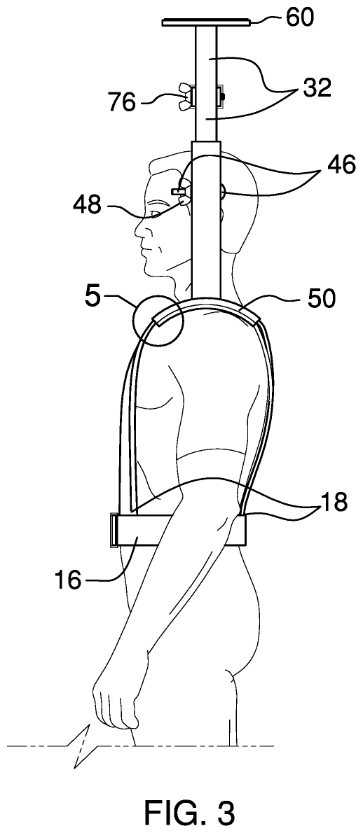

A pair of posts 30 is coupled singly to the pair of shoulder straps 14. The posts 30 are substantially parallel and substantially vertically positioned when the user is uprightly positioned, as shown in FIG. 3. Each post 30 comprises a plurality of nested sections 32 so that the post 30 is selectively extensible. The posts 30 being selectively extensible allows the user to perform length adjustment so that the posts 30 are suitable for a particular environment in which the user is working, such as in a room with high ceiling. Each of the posts 30 may have a rectangular cross section 34, or a cross section of another shape, such as, but not limited to, circular, oval, and the like. The plurality of nested sections 32 comprises an upper section 36 that is selectively extensible from, and selectively engageable to, a lower section 38, as shown in FIG. 3.

The lower section 38 has a set of first holes 40 positioned therein. The upper section 36 has a set of second holes 42 positioned therein. Respective ones of the first holes 40 are selectively alignable with respective ones of the second holes 42, positioning the respective ones of the first holes 40 and the respective ones of the second holes 42 for insertion of a post fastener 44 to fixedly position the upper section 36 relative to the lower section 38. The post fastener 44 may comprise a bolt 46 and a wingnut 48, or other fastening means, such as, but not limited to, thumbscrews, spring-loaded pins, and the like.

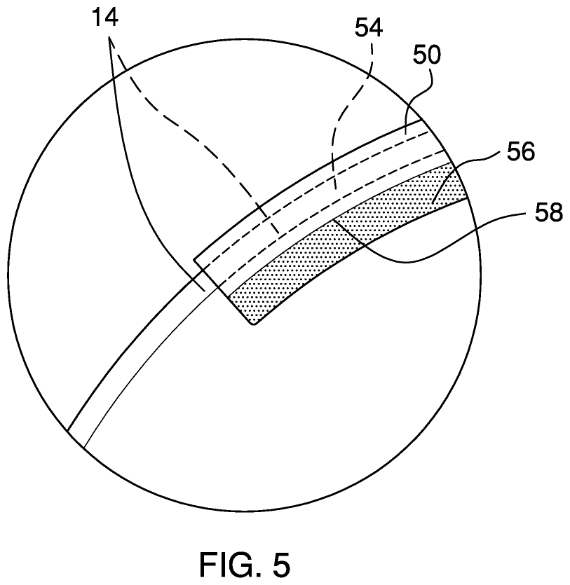

Each of a pair of bars 50 is coupled to a lower end 52 of a respective one of the posts 30. The bars 50 are arcuate so that each bar 50 is configured to insert a respective shoulder of the user as the harness 12 is donned by the user. Each bar 50 has a channel 54 that is positioned therethrough, with an associated shoulder strap 14 being positioned through the channel 54, as shown in FIG. 5, so that the pair of posts 30 is coupled to the harness 12.

Each of a pair of pads 56 is coupled to a lower face 58 of a respective one of the bars 50. The pair of pads 56 is configured to cushion the pair of bars 50 on the shoulders of the user. The pads 56 comprise at least one of foamed elastomer, rubber, and silicone.

Each of a pair of plates 60 is coupled to an upper end 62 of a respective one of the pair of posts 30. The pair of plates 60 is configured to support a panel overhead, enabling the user to position the panel in abutment to the overhead substrate. Hands of the user remain free for fastening the panel to the substrate. The plates 60 may be rectangularly shaped, as shown in FIG. 3, or alternatively shaped, such as, but not limited to, circularly shaped, triangularly shaped, and the like. The present invention also anticipates the pair of plates 60 comprising a single plate 60 that is coupled to and which extends between the upper ends 62 of the pair of posts 30.

Each of a pair of sheets 64 is coupled to an upper surface 66 of a respective one of the pair of plates 60. The sheets 64 comprise nonslip material and thus are configured to deter slippage of the panel that is positioned upon the pair of plates 60. The sheets 64 may comprise at least one of rubber, silicone, foamed elastomer, and cork, or other nonslip material, such as, but not limited to, sandpaper, pressure sensitive reversible adhesive, and the like.

A crossmember 68 is coupled to and extends between the upper sections 36 of the posts 30. The crossmember 68 is positioned to retain the posts 30 in a substantially parallel configuration. Each opposing endpoint 70 of the crossmember 68 has a pair of tabs 72 coupled thereto and extending therefrom, as shown in FIG. 3. Each tab 72 has an end hole 74 positioned therethrough. The end holes 74 are selectively alignable with respective ones of the second holes 42, positioning the end holes 74 and the respective ones of the second holes 42 for insertion of a crossbeam fastener 76 to removably couple the crossmember 68 to the pair of posts 30. The crossmember 68 being removably couplable to the pair of posts 30 allows the user to adjust the crossmember 68 so that it does not contact the head of the user. The crossbeam fastener 76 may comprise a crossbeam thumbscrew 78 and a crossbeam nut 80, or other fastening means, such as, but not limited to, bolts and wingnuts, spring-loaded pins, and the like.

The crossmember 68 comprises a first segment 82 that is selectively extensible from, and which is selectively engageable to, a second segment 84 so that the crossmember 68 is selectively length adjustable. This allows the posts 30 to be separated selectively to match a width of the shoulders of the user. The first segment 82 has a set of first orifices 86 positioned therein. The second segment 84 has a set of second orifices 88 positioned therein. Respective ones of the first orifices 86 are selectively alignable with respective ones of the second orifices 88, positioning the respective ones of the first orifices 86 and the respective ones of the second orifices 88 for insertion of a medial fastener 90 to fixedly position the first segment 82 relative to the second segment 84. The medial fastener 90 may comprise a medial thumbscrew 92 and a medial nut 94, or other fastening means, such as, but not limited to, bolts and wingnuts, spring-loaded pins, and the like.

In use, the harness 12 is donned by the user with the chest side release buckle 28 and the waist side release buckle 22 being engaged to secure the harness 12 to the user.

The posts 30 extend above the head of the user so that the panel can be supported upon the pair of plates 60. The user thus is positioned to motivate the panel upwardly into abutment with the overhead substrate, typically joists or framing, while the hands of the user remain free to fasten the panel to the overhead substrate.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A user attachable overhead panel support device comprising:
a harness configured for positioning on and coupling to a torso of a user, such that each of a pair of shoulder straps of the harness is positioned over a respective shoulder of the user;
a pair of posts coupled singly to the pair of shoulder straps, such that the posts are substantially parallel and substantially vertically positioned when the user is uprightly positioned; and
a pair of plates each coupled to an upper end of a respective one of the pair of posts, wherein the pair of plates is configured for supporting a panel overhead, enabling the user to position the panel in abutment to an overhead substrate, with hands of the user being free for fastening the panel to the substrate.

2. The user attachable overhead panel support device of claim 1, wherein the harness comprises:
a belt configured for positioning around and coupling to a waist of the user, each shoulder strap having opposing ends coupled to the belt, the shoulder straps crossing and being mutually coupled distal from opposing termini of the belt, such that the pair of shoulder straps is X-shaped along a back of the user;
a pair of couplers, one coupler being engaged to one of the opposing termini of the belt, the other coupler being slidably engaged to the belt proximate to the other of the opposing termini; and
the couplers being selectively mutually engageable, wherein the couplers are configured for removably coupling the belt around the waist of the user.

3. The user attachable overhead panel support device of claim 2, wherein the pair of couplers comprises a waist side release buckle.

4. The user attachable overhead panel support device of claim 2, further comprising:
a pair of cross straps each coupled to and extending from a respective one of the pair of shoulder straps;
a pair of connectors, one connector being engaged to one of the cross straps distal from an associated shoulder strap, the other connector being slidably engaged to the other of the cross straps distal from an associated shoulder strap; and
the connectors being selectively mutually engageable, wherein the connectors are configured for securing the pair of cross straps across a chest of the user.

5. The user attachable overhead panel support device of claim 4, wherein the pair of connectors comprises a chest side release buckle.

6. The user attachable overhead panel support device of claim 1, wherein each post comprises a plurality of nested sections, such that the post is selectively extensible, the plurality of nested sections comprising an upper section selectively extensible from, and selectively engageable to, a lower section.

7. The user attachable overhead panel support device of claim 6, wherein:
the lower section has a set of first holes positioned therein;
the upper section has a set of second holes positioned therein, such that respective ones of the first holes are selectively alignable with respective ones of the second holes, positioning the respective ones of the first holes and the respective ones of the second holes for insertion of a post fastener, for fixedly positioning the upper section relative to the lower section.

8. The user attachable overhead panel support device of claim 7, wherein the post fastener comprises a bolt and a wingnut.

9. The user attachable overhead panel support device of claim 1, wherein:
each of the posts has a rectangular cross section; and
the plates are rectangularly shaped.

10. The user attachable overhead panel support device of claim 1, further comprising:
a pair of bars each coupled to a lower end of a respective one of the posts, the bars being arcuate, such that each bar is configured for inserting a respective shoulder of the user as the harness is donned by the user;
each bar having a channel positioned therethrough with an associated shoulder strap positioned through the channel, such that the pair of posts is coupled to the harness; and
a pair of pads each coupled to a lower face of a respective one of the bars, wherein the pair of pads is configured for cushioning the pair of bars on the shoulders of the user.

11. The user attachable overhead panel support device of claim 10, wherein the pads comprise at least one of foamed elastomer, rubber, and silicone.

12. The user attachable overhead panel support device of claim 1, further comprising a pair of sheets each coupled to an upper surface of a respective one of the pair of plates, the sheets comprising nonslip material, wherein the sheets are configured for deterring slippage of the panel positioned upon the pair of plates.

13. The user attachable overhead panel support device of claim 12, wherein the sheets comprise at least one of rubber, silicone, foamed elastomer, and cork.

14. The user attachable overhead panel support device of claim 7, further comprising a crossmember coupled to and extending between the upper sections of the posts, such that the crossmember is positioned for retaining the posts in a substantially parallel configuration.

15. The user attachable overhead panel support device of claim 14, wherein:
each opposing endpoint of the crossmember has a pair of tabs coupled thereto and extending therefrom; and
each tab has an end hole positioned therethrough such that the end holes are selectively alignable with respective ones of the second holes, positioning the end holes and the respective ones of the second holes for insertion of a crossbeam fastener, for removably coupling the crossmember to the pair of posts.

16. The user attachable overhead panel support device of claim 15, wherein the crossbeam fastener comprises a crossbeam thumbscrew and a crossbeam nut.

17. The user attachable overhead panel support device of claim 14, wherein the crossmember comprises a first segment selectively extensible from, and selectively engageable to, a second segment such that the crossmember is selectively length adjustable.

18. The user attachable overhead panel support device of claim 17, wherein:
the first segment has a set of first orifices positioned therein; and
the second segment having a set of second orifices positioned therein, such that respective ones of the first orifices are selectively alignable with respective ones of the second orifices, positioning the respective ones of the first orifices and the respective ones of the second orifices for insertion of a medial fastener, for fixedly positioning the first segment relative to the second segment.

19. The user attachable overhead panel support device of claim 18, wherein the medial fastener comprises a medial thumbscrew and a medial nut.

20. A user attachable overhead panel support device comprising:
a harness configured for positioning on and coupling to a torso of a user, such that each of a pair of shoulder straps of the harness is positioned over a respective shoulder of the user, the harness comprising:
a belt configured for positioning around and coupling to a waist of the user, each shoulder strap having opposing ends coupled to the belt, the shoulder straps crossing and being mutually coupled distal from opposing termini of the belt, such that the pair of shoulder straps is X-shaped along a back of the user,
a pair of couplers, one coupler being engaged to one of the opposing termini of the belt, the other coupler being slidably engaged to the belt proximate to the other of the opposing termini, the couplers being selectively mutually engageable, wherein the couplers are configured for removably coupling the belt around the waist of the user, the pair of couplers comprising a waist side release buckle,
a pair of cross straps each coupled to and extending from a respective one of the pair of shoulder straps, and
a pair of connectors, one connector being engaged to one of the cross straps distal from an associated shoulder strap, the other connector being slidably engaged to the other of the cross straps distal from an associated shoulder strap, the connectors being selectively mutually engageable, wherein the connectors are configured for securing the pair of cross straps across a chest of the user, the pair of connectors comprising a chest side release buckle;
a pair of posts coupled singly to the pair of shoulder straps, such that the posts are substantially parallel and substantially vertically positioned when the user is uprightly positioned, each post comprising a plurality of nested sections, such that the post is selectively extensible, the plurality of nested sections comprising an upper section selectively extensible from, and selectively engageable to, a lower section, the lower section having a set of first holes positioned therein, the upper section having a set of second holes positioned therein, such that respective ones of the first holes are selectively alignable with respective ones of the second holes, positioning the respective ones of the first holes and the respective ones of the second holes for insertion of a post fastener, for fixedly positioning the upper section relative to the lower section, the post fastener comprising a bolt and a wingnut, each of the posts having a rectangular cross section;
a pair of bars each coupled to a lower end of a respective one of the posts, the bars being arcuate such that each bar is configured for inserting a respective shoulder of the user as the harness is donned by the user, each bar having a channel positioned therethrough with an associated shoulder strap positioned through the channel, such that the pair of posts is coupled to the harness;
a pair of pads each coupled to a lower face of a respective one of the bars, wherein the pair of pads is configured for cushioning the pair of bars on the shoulders of the user, the pads comprising at least one of foamed elastomer, rubber, and silicone;
a pair of plates each coupled to an upper end of a respective one of the pair of posts, wherein the pair of plates is configured for supporting a panel overhead, enabling the user to position the panel in abutment to an overhead substrate, with hands of the user being free for fastening the panel to the substrate, the plates being rectangularly shaped;
a pair of sheets each coupled to an upper surface of a respective one of the pair of plates, the sheets comprising nonslip material, wherein the sheets are configured for deterring slippage of the panel positioned upon the pair of plates, the sheets comprising at least one of rubber, silicone, foamed elastomer, and cork; and
a crossmember coupled to and extending between the upper sections of the posts, such that the crossmember is positioned for retaining the posts in a substantially parallel configuration, each opposing endpoint of the crossmember having a pair of tabs coupled thereto and extending therefrom, each tab having an end hole positioned therethrough, such that the end holes are selectively alignable with respective ones of the second holes, positioning the end holes and the respective ones of the second holes for insertion of a crossbeam fastener, for removably coupling the crossmember to the pair of posts, the crossbeam fastener comprising a crossbeam thumbscrew and a crossbeam nut, the crossmember comprising a first segment selectively extensible from, and selectively engageable to, a second segment, such that the crossmember is selectively length adjustable, the first segment having a set of first orifices positioned therein, the second segment having a set of second orifices positioned therein, such that respective ones of the first orifices are selectively alignable with respective ones of the second orifices, positioning the respective ones of the first orifices and the respective ones of the second orifices for insertion of a medial fastener, for fixedly positioning the first segment relative to the second segment, the medial fastener comprising a medial thumbscrew and a medial nut.
